(19) United States
(12) Patent Application Publication
(10) Pub. No.: US 2024/0220671 A1
(43) Pub. Date: Jul. 4, 2024

(54) Circuits And Methods For Tampering Detection

(71) Applicant: Altera Corporation, San Jose, CA (US)

(72) Inventors: Teik Wah Lim, Bayan Lepas (MY); Atul Maheshwari, Portland, OR (US); Michael Neve de Mevergnies, Guidel (FR); Maggie Jauregui, Portland, OR (US); Chandni Bhowmik, Banks, OR (US)

(73) Assignee: Altera Corporation, San Jose, CA (US)

(21) Appl. No.: 18/610,682

(22) Filed: Mar. 20, 2024

(51) Int. Cl. G06F 21/86; H03K 19/003

(52) U.S. Cl. CPC G06F 21/86; H03K 19/003

(57) ABSTRACT

An integrated circuit includes an anti-tamper circuit having a resistor. The resistor includes conductors in a conductive layer of the integrated circuit. Each of the conductors extends across a width of the integrated circuit. The conductors are spaced apart across a length of the integrated circuit. The anti-tamper circuit generates an output signal indicative of changes in a resistance of the resistor caused by tampering that affects the conductors.

### TECHNICAL FIELD

The present disclosure relates to electronic integrated circuits, and more particularly, to circuits and methods for detecting tampering in integrated circuits.

### BACKGROUND

Configurable integrated circuits (ICs) can be configured by users to implement desired custom logic functions. In a typical scenario, a logic designer uses computer-aided design (CAD) tools to design a custom circuit design. When the design process is complete, the computer-aided design tools generate an image containing configuration data bits. The configuration data bits are then loaded into configuration memory elements that configure configurable logic circuits in the integrated circuit to perform the functions of the custom circuit design.

### BRIEF DESCRIPTION OF DRAWINGS

FIG. 1 is a diagram that illustrates an example of an integrated circuit (IC) package that includes an integrated circuit die and a package substrate.

FIG. 2 is a layout diagram that illustrates a top down view of examples of conductors formed in signal layers in the integrated circuit die shown in FIG. 1.

FIG. 3 is a diagram that illustrates an example of an anti-tamper circuit in the integrated circuit die of FIG. 1.

FIG. 4A is a flow chart that illustrates examples of operations that can be performed during the profiling mode of the anti-tamper circuit of FIG. 3.

FIG. 4B is a flow chart that illustrates examples of operations that can be performed during the protection mode of the anti-tamper circuit of FIG. 3.

FIG. 5 illustrates an example of a configurable logic integrated circuit (IC).

FIG. 6A is a block diagram of a system that can be used to implement a circuit design to be programmed onto a programmable logic device using design software.

FIG. 6B is a diagram that depicts an example of a programmable logic device that includes three fabric die and two base die that are connected to one another via microbumps.

FIG. 7 is a block diagram illustrating a computing system configured to implement one or more aspects of the embodiments disclosed herein.

### DETAILED DESCRIPTION

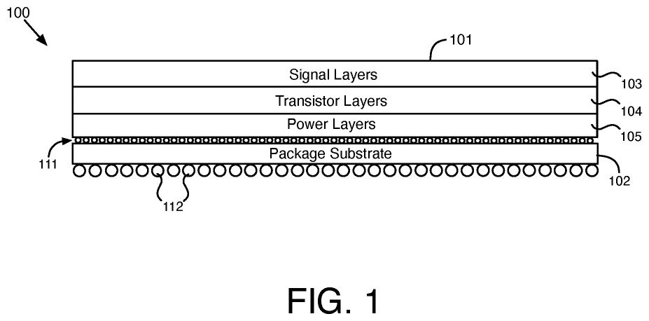

FIG. 1 is a diagram that illustrates an example of an integrated circuit (IC) package 100 that includes an integrated circuit die 101 and a package substrate 102. The integrated circuit (IC) die 101 is coupled to the package substrate 102 through conductive microbumps 111. The package substrate 102 can be coupled to a circuit board (not shown) through conductive balls 112. The IC die 101 can be any type of integrated circuit, such as a configurable IC (e.g., a field programmable gate array (FPGA) or programmable logic device), a microprocessor IC, a graphics processing unit IC, a memory IC, an application specific IC, a transceiver IC, etc. FIG. 1 shows a cross sectional view of the IC package 100.

The IC die 101 includes signal layers 103, transistor layers 104, and power layers 105. The transistor layers 104 include layers of material (e.g., of semiconductor and metal) that form transistors. The power layers 105 include conductors formed in layers of conductive material that are used to transmit power (e.g., supply and ground voltages) to the transistors in transistor layers 104. Signal layers 103 include conductors formed in layers of conductive material that are used to transmit signals (e.g., data signals, control signals, clock signals, etc.) to the transistors in transistor layers 104.

Because the signal layers 103 are exposed on the top side of the IC die 101, the signal layers 103 may provide an opportunity for a physical attack on the IC die 101. For example, an attacker may be able to physically pierce into and/or through the signal layers 103 from the top side of IC die 101 to access the signal layers 103 and/or the transistor layers 104. An attacker may be able to perform a physical attack on IC die 101 that circumvents security protections, as examples, by physically accessing secure signals transmitted through signals layers 103 and/or valuable information stored in transistor layers 104.

According to some examples disclosed herein, circuits and methods are provided for detecting a physical attack on an integrated circuit (IC) die by monitoring a voltage generated by a resistor divider that includes a resistor formed in signal layers of the IC die. A resistance value is selected for the resistor divider during a profiling mode to generate a detection voltage. The detection voltage is stored in a lock-step circuit in the IC die. During a protection mode, anti-tamper compare logic circuitry in the IC die compares the detection voltage generated by the resistor divider to the detection voltage stored in the lock-step circuit to determine if a physical attack has occurred in the signal layers of the IC die.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs) and programmable logic devices. As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

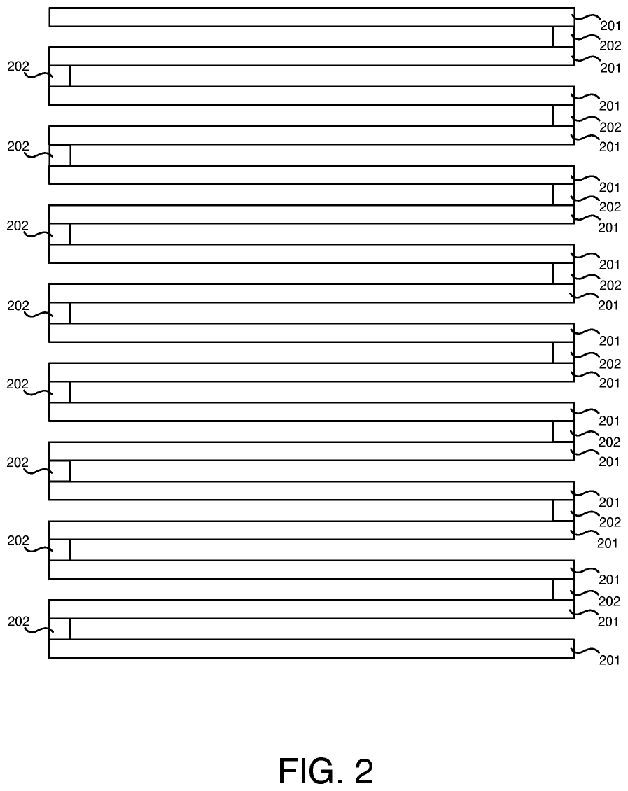

FIG. 2 is a layout diagram that illustrates a top down view of examples of conductors formed in signal layers in the IC die 101 shown in Figure (FIG. 1. FIG. 2 illustrates an exemplary layout of first conductors 201 formed in a first conductive signal layer of IC die 101 and second conductors 202 formed in a second conductive signal layer of IC die 101. The first and second conductive signal layers can, as an example, be formed of metal. As an example, the first conductive signal layer that includes conductors 201 can be the top-most layer of IC die 101, and the second conductive signal layer that includes conductors 202 can be the next layer below the first conductive signal layer. In this example, the conductors 201-202 are in the signal layers 103 of IC die 101 shown in FIG. 1. In another implementation, the conductors 201-202 can be duplicated in additional signal layers that are located under the power layers 105 on the back end of IC die 101, directly above the microbumps 111.

IC die 101 includes first conductors 201 that extend across the width of IC die 101. Each of the first conductors 201 is rectangular and spans most or all of the width of IC die 101 (i.e., left to right in the view shown in FIG. 2) from a top down perspective. Each of the second conductors 202 couples together two adjacent ones of the first conductors 201. As a result, the conductors 201 and 202 are coupled together to form an alternating stepped conductive path that extends back and forth across the length and width of IC die 101.

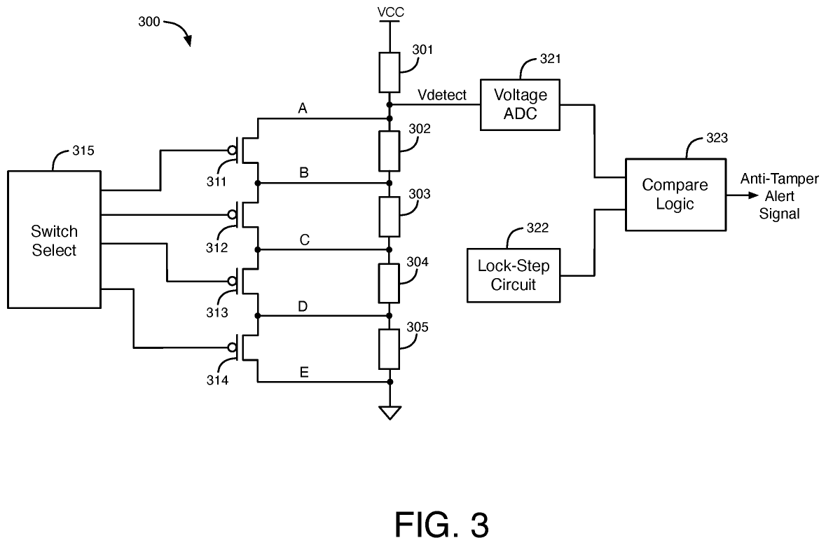

The conductors 201 are spaced apart across the length of IC die 101 (i.e., from top to bottom in the view shown in FIG. 2). IC die 101 includes enough of the conductors 201 to extend across the length of IC die 101. Although 17 of the conductors 201 are shown in FIG. 2 as an example, an IC die implementing techniques disclosed herein can include as many of the conductors 201 that are needed to be spaced apart across the entire length of the IC die, such that the maximum area in the IC die that does not have one of the conductors 201-202 in the signal layers from a top down perspective is less than the length of each conductor 202. According to an exemplary implementation that is disclosed in further detail herein with respect to FIG. 3, conductors 201 and 202 are coupled together to form a resistor that is used by an anti-tamper circuit to detect physical attacks on IC die 101.

FIG. 3 is a diagram that illustrates an example of an anti-tamper circuit 300 in the IC die 101. Anti-tamper circuit 300 includes 5 resistors 301-305, 4 p-channel field-effect transistors (FETs) 311-314, switch select circuit 315, voltage analog-to-digital converter (ADC) circuit 321, lock-step circuit 322, and compare logic circuit 323. According to an exemplary implementation, resistor 301 includes the conductors 201 and the conductors 202 shown in FIG. 2. In this implementation, the conductors 201 and 202 are coupled together as shown in FIG. 2 to form the resistor 301 of FIG. 3. The conductors 201 and 202 can be, for example, in two of the signal layers 103 in IC die 101.

In another implementation, IC die 101 can also have additional signal layers (not shown in FIG. 1) that include another set of the conductors 201-202 that are coupled as shown in FIG. 2. These additional signal layers are located under power layers 105 on the back side of IC die 101, above the microbumps 111. In this implementation, the resistor 301 of FIG. 3 includes a first set of the conductors 201-202 (coupled together as shown in FIG. 2) in two of the signal layers 103 shown in FIG. 1, and the resistor 301 also includes a second set of the conductors 201-202 (coupled together as shown in FIG. 2) in two additional signal layers located under the power layers 105 on the back side of IC die 101. In this implementation, the first set of the conductors 201-202 is coupled to the second set of the conductors 201-202 through vias and conductors in power layers 105 and transistor layers 104 to form the resistor 301.

Resistors 301-305 are coupled in series between a supply voltage VCC and a ground voltage to form a resistor divider. P-channel FET 311 is coupled in parallel with resistor 302 between nodes A and B. P-channel FET 312 is coupled in parallel with resistor 303 between nodes B and C. P-channel FET 313 is coupled in parallel with resistor 304 between nodes C and D. P-channel FET 314 is coupled in parallel with resistor 305 between nodes D and E. According to a specific example that is not intended to be limiting, each of the resistors 302, 303, 304, and 305 can have one-eighth of the resistance of resistor 301. The anti-tamper circuit 300 (except resistor 301) can be formed in the transistor layers 104 of IC die 101.

The gates of transistors 311-314 are coupled to switch select circuit 315. The voltage ADC circuit 321 is coupled to node A. The voltage ADC circuit 321 converts the voltage Vdetect generated at node A to a digital value that is provided to compare logic circuit 323. Compare logic circuit 323 compares the digital value generated by voltage ADC circuit 321 to a digital value stored in lock-step circuit 322 to generate an anti-tamper alert signal, as described in further detail below.

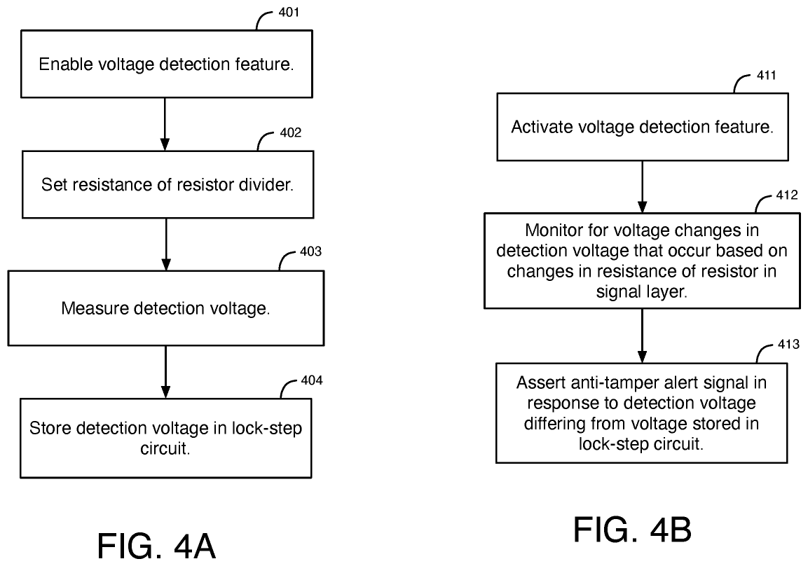

The anti-tamper circuit 300 can be operated in a profiling mode and in a protection mode. The profiling mode is described in detail with respect to FIG. 4A. During the profiling mode, the voltage detection feature provided by the anti-tamper circuit 300 of FIG. 3 can be enabled in operation 401, for example, in response to input from a user or the manufacturer, as shown in FIG. 4A. The voltage detection feature can, for example, be enabled by a fuse setting in IC die 101. In this example, the fuse setting is not set by default, and the voltage detection feature is not enabled until input is received enabling the voltage detection feature.

In operation 402, the resistance of the resistor divider formed by resistors 301-305 is set to a random value (or pseudo-random value) based on a digital output value that is generated by the switch select circuit 315 and provided to the gates of the p-channel FETs 311-314. As an example, the switch select circuit 315 can include a linear feedback shift register (LFSR) circuit that generates a random (or pseudo-random) digital value in operation 402. The digital output value generated by switch select circuit 315 is provided to the gates of FETs 311-314 to randomly select the total resistance between node A and the ground voltage at node E, so that an attacker cannot determine the exact value of the detection voltage Vdetect. The digital output value generated by switch select circuit 315 can turn on any of the p-channel FETs 311-314 to short the respective ones of the resistors 302-305 in the resistor divider. The digital output value generated by switch select circuit 315 can turn off any of the p-channel FETs 311-314 to add the resistance of the respective ones of the resistors 302-305 to the resistor divider. For example, a digital code of 1010 generated by the switch select circuit 315 can turn off transistors 311 and 313 and turn on transistors 312 and 314, shorting transistors 303 and 305, and causing the total resistance between node A and node E to equal the resistance of resistor 302 plus the resistance of resistor 304.

In operation 403, the detection voltage Vdetect is measured, for example, by the voltage ADC circuit 321. In operation 404, the measured detection voltage Vdetect is stored in the lock-step circuit 322. The measured detection voltage Vdetect that is stored in lock-step circuit 322 can be the digital output of voltage ADC circuit 321. The lock-step circuit 322 can include non-volatile storage (e.g., on-die fuses) that stores the measured detection voltage Vdetect. In some implementations, the detection voltage Vdetect is measured in operation 403 under different environmental conditions (e.g., at different temperatures of IC die 101), and each of the measured detection voltages is stored in lock-step circuit 322 in operation 404.

The protection mode is described in detail with respect to FIG. 4B. In operation 411, the voltage detection feature provided by the anti-tamper circuit 300 of FIG. 3 is activated, as examples, in response to a signal from a fuse in IC die 101 or from a bitstream setting in IC die 101. In operation 412, the anti-tamper circuit 300 monitors voltage changes in the detection voltage Vdetect that occur based on changes in the resistance of the resistor 301 in the signal layer. For example, if an attacker pierces through the conductive signal layers that include conductors 201-202 shown in FIG. 2, the resistance of resistor 301 changes, and the detection voltage Vdetect changes based on the change in the resistance of resistor 301. The voltage ADC circuit 321 then changes its digital output based on the change in the detection voltage Vdetect.

During the protection mode, the lock-step circuit 322 outputs a digital value that indicates the detection voltage Vdetect measured in operation 403 and stored in operation 404. The compare logic circuit 323 compares the digital output of voltage ADC circuit 321 with the digital value of the detection voltage Vdetect that was measured during the profiling mode and stored in and output by lock-step circuit 322. In operation 413, the compare logic circuit 323 asserts an anti-tamper alert signal in response to the detection voltage Vdetect as indicated by the digital output of voltage ADC circuit 321 differing from the detection voltage Vdetect stored in and output by the lock-step circuit 322.

If multiple values of the detection voltage Vdetect were measured under different environmental conditions and stored in the lock-step circuit 322 in the profiling mode, the lock-step circuit 322 only outputs the measured detection voltage Vdetect that corresponds to the current environmental conditions measured in IC die 101. In these implementations, compare logic circuit 323 also asserts the anti-tamper alert signal based on the detection voltage Vdetect as indicated by the digital output of voltage ADC circuit 321 being different from the digital value of the detection voltage Vdetect output by the lock-step circuit 322.

In response to the anti-tamper alert signal being asserted when voltage tampering is detected by the anti-tamper circuit 300, the IC die 101 can perform additional security functions, such as an IC die reset or shutdown to prevent undesired system execution. The IC die 101 can also, or alternatively, trigger clearing of memory contents in IC die 101 or other anti-tamper responses. The additional security functions can, for example, be selected by the IC die owner via a bitstream configuration.

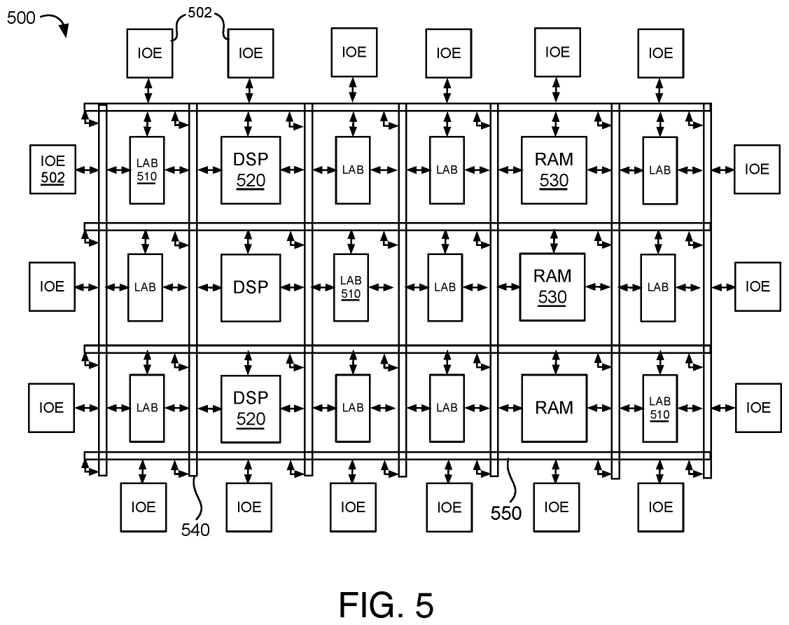

FIG. 5 illustrates an example of a configurable logic integrated circuit (IC) 500 that can include, for example, the circuitry disclosed herein with respect to any, some, or all of FIGS. 1, 2, 3, and/or 4A-4B. As shown in FIG. 5, the configurable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals. The configurable functional circuit blocks shown in FIG. 5 can, for example, be configured to perform the functions of any of the circuitry disclosed herein with respect to FIGS. 3 and/or 4A-4B.

In addition, programmable logic IC 500 can have input/output elements (IOEs) 502 for driving signals off of programmable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the programmable logic IC 500 can have input/output elements 502 arranged in different ways. For example, input/output elements 502 can form one or more columns, rows, or islands of input/output elements that may be located anywhere on the programmable logic IC 500.

The programmable logic IC 500 can also include programmable interconnect circuitry in the form of vertical routing channels 540 (i.e., interconnects formed along a vertical axis of programmable logic IC 500) and horizontal routing channels 550 (i.e., interconnects formed along a horizontal axis of programmable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein with respect to FIGS. 1, 2, 3, and 4A-4B can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Programmable logic IC 500 can contain programmable memory elements. Memory elements can be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, programmable logic IC 500 can include configuration memory that is organized in sectors, whereby a sector can include the configuration RAM bits that specify the functions and/or interconnections of the subcomponents and wires in or crossing that sector. Each sector can include separate data and address registers.

The programmable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

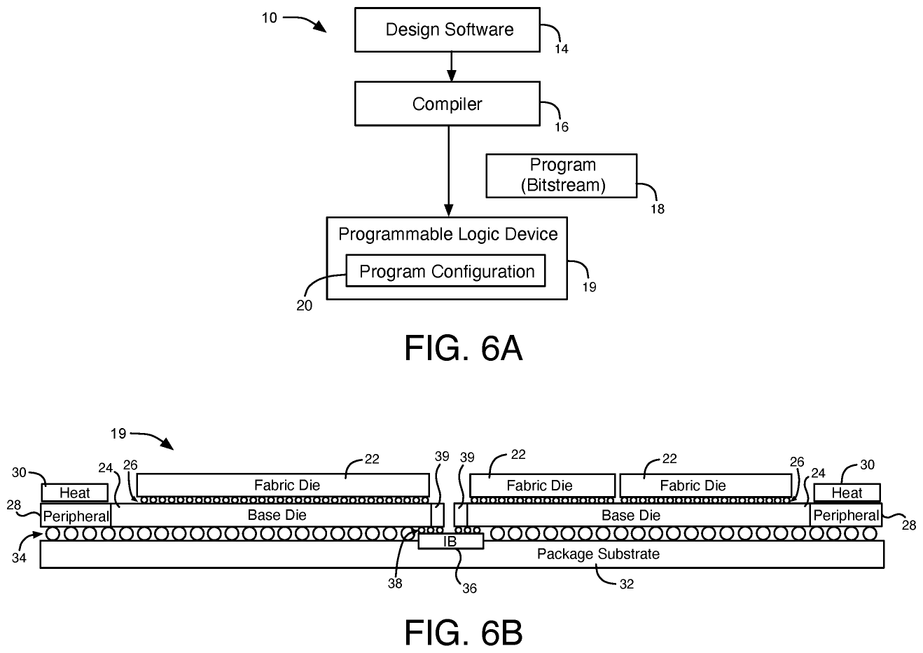

FIG. 6A illustrates a block diagram of a system 10 that can be used to implement a circuit design to be programmed into a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6B, but many others can be used, and it should be understood that this disclosure is intended to encompass any suitable programmable logic device where programmable logic fabric and fabric support circuitry are at least partially separated on different integrated circuit die.

FIG. 6B is a diagram that depicts an example of the programmable logic device 19 that includes three fabric die 22 and two base die 24 that are connected to one another via microbumps 26. In the example of FIG. 6B, at least some of the programmable logic fabric of the programmable logic device 19 is in the three fabric die 22, and at least some of the fabric support circuitry that operates the programmable logic fabric is in the two base die 24. For example, some of the circuitry of configurable IC 500 shown in FIG. 5 (e.g., LABs 510, DSP 520, and RAM 530) can be located in the fabric die 22 and some of the circuitry of IC 500 (e.g., input/output elements 502) can be located in the base die 24.

Although the fabric die 22 and base die 24 appear in a one-to-one relationship or a two-to-one relationship in FIG. 6B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

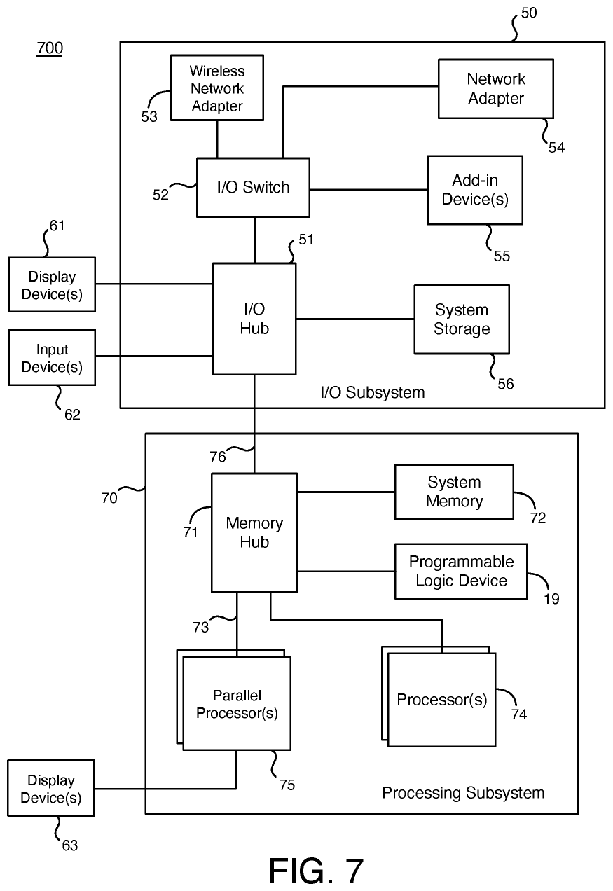

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit comprising an anti-tamper circuit comprising a resistor, wherein the resistor comprises conductors in a conductive layer of the integrated circuit, wherein each of the conductors extends across a width of the integrated circuit, wherein the conductors are spaced apart across a length of the integrated circuit, and wherein the anti-tamper circuit generates an output signal indicative of changes in a first resistance of the resistor caused by tampering that affects the conductors.

In Example 2, the integrated circuit of Example 1 may optionally include, wherein the anti-tamper circuit further comprises: a switch select circuit that generates a pseudo-random digital value.

In Example 3, the integrated circuit of Example 2 may optionally include, wherein the anti-tamper circuit further comprises: a resistor divider comprising the resistor; and transistors coupled to the resistor divider, wherein the transistors control a voltage across the resistor divider based on the pseudo-random digital value.

In Example 4, the integrated circuit of any one of Examples 2-3 may optionally include, wherein the switch select circuit comprises a linear feedback shift register.

In Example 5, the integrated circuit of any one of Examples 1-4 may optionally include, wherein the anti-tamper circuit further comprises: a voltage analog-to-digital converter circuit that converts a voltage at a node coupled to the resistor to a digital value.

In Example 6, the integrated circuit of any one of Examples 1-5 may optionally include, wherein the anti-tamper circuit further comprises: a compare logic circuit that generates the output signal based on a comparison between a first voltage and a second voltage, wherein the first voltage is generated at a node coupled to the resistor during a protection mode of the anti-tamper circuit, and wherein the second voltage is generated at the node during a profiling mode of the anti-tamper circuit.

In Example 7, the integrated circuit of any one of Examples 1-6 may optionally include, wherein the conductors are coupled in an alternating pattern that extends back and forth across the length and the width of the integrated circuit.

In Example 8, the integrated circuit of any one of Examples 1-7 may optionally include, wherein the resistor is part of a resistor divider in the anti-tamper circuit, wherein the anti-tamper circuit generates a second resistance across the resistor divider based on a pseudo-random digital value, and wherein the anti-tamper circuit generates the output signal based on the first resistance and based on the second resistance.

In Example 9, the integrated circuit of any one of Examples 1-8 may optionally include, wherein the anti-tamper circuit generates the output signal based on the first resistance of the resistor and based on a second resistance that is determined based on a randomly generated value used to control transistors.

Example 10 is a method for detecting an attack on an integrated circuit die, wherein the method comprises: sensing a first resistance of a resistor using a voltage detection circuit, wherein the resistor comprises conductors in a conductive layer of the integrated circuit die, wherein each of the conductors extends across a width of the integrated circuit die, and wherein the conductors are spaced apart across a length of the integrated circuit die; and generating an output signal based on a change in the first resistance of the resistor that is caused by tampering affecting the conductors.

In Example 11, the method of Example 10 further comprises: generating a pseudo-random digital value using a switch select circuit; and setting a second resistance across a resistor divider based on the pseudo-random digital value, wherein the resistor divider comprises the resistor.

In Example 12, the method of any one of Examples 10-11 may optionally include, wherein generating the output signal further comprises generating a detection voltage using a resistor divider.

In Example 13, the method of any one of Examples 10-12 may optionally include, wherein generating the output signal further comprises: generating a first voltage at a node coupled to the resistor during a protection mode; generating a second voltage at the node during a profiling mode; storing the second voltage; and generating the output signal based on a comparison between the first voltage and the second voltage.

In Example 14, the method of any one of Examples 10-13 may optionally include, wherein the conductors are coupled in a pattern that extends back and forth across the length and the width of the integrated circuit die.

In Example 15, the method of any one of Examples 10-14 further comprising: shutting down the integrated circuit die in response to the output signal being asserted.

Example 16 an anti-tamper circuit comprising: a resistor divider; a switch select circuit that selects a resistance of the resistor divider based on a pseudo-random value; and voltage detection circuitry that generates an anti-tamper alert signal indicating when a voltage at a node in the resistor divider differs from a stored value.

In Example 17, the anti-tamper circuit of Example 16 may optionally include, wherein the resistor divider comprises conductors in a conductive layer of an integrated circuit die, wherein each of the conductors extends across a width of the integrated circuit die, and wherein the conductors are spaced apart across a length of the integrated circuit die.

In Example 18, the anti-tamper circuit of any one of Examples 16-17 further comprises: transistors controlled by the switch select circuit, wherein each of the transistors is coupled in parallel with a resistor in the resistor divider.

In Example 19, the anti-tamper circuit of any one of Examples 16-18 may optionally include, wherein the voltage detection circuitry comprises compare logic circuitry that compares the voltage at the node in the resistor divider with the stored value.

In Example 20, the anti-tamper circuit of any one of Examples 16-19 may optionally include, wherein the stored value is generated based on the voltage at the node in the resistor divider during a profiling mode of the anti-tamper circuit, and wherein the voltage detection circuitry generates the anti-tamper alert signal during a protection mode of the anti-tamper circuit.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
an anti-tamper circuit comprising a resistor, wherein the resistor comprises conductors in a conductive layer of the integrated circuit, wherein each of the conductors extends across a width of the integrated circuit, wherein the conductors are spaced apart across a length of the integrated circuit, and wherein the anti-tamper circuit generates an output signal indicative of changes in a first resistance of the resistor caused by tampering that affects the conductors.

2. The integrated circuit of claim 1, wherein the anti-tamper circuit further comprises:
a switch select circuit that generates a pseudo-random digital value.

3. The integrated circuit of claim 2, wherein the anti-tamper circuit further comprises:
a resistor divider comprising the resistor; and
transistors coupled to the resistor divider, wherein the transistors control a voltage across the resistor divider based on the pseudo-random digital value.

4. The integrated circuit of claim 3, wherein the switch select circuit comprises a linear feedback shift register.

5. The integrated circuit of claim 1, wherein the anti-tamper circuit further comprises:
a voltage analog-to-digital converter circuit that converts a voltage at a node coupled to the resistor to a digital value.

6. The integrated circuit of claim 1, wherein the anti-tamper circuit further comprises:
a compare logic circuit that generates the output signal based on a comparison between a first voltage and a second voltage, wherein the first voltage is generated at a node coupled to the resistor during a protection mode of the anti-tamper circuit, and wherein the second voltage is generated at the node during a profiling mode of the anti-tamper circuit.

7. The integrated circuit of claim 1, wherein the conductors are coupled in an alternating pattern that extends back and forth across the length and the width of the integrated circuit.

8. The integrated circuit of claim 1, wherein the resistor is part of a resistor divider in the anti-tamper circuit, wherein the anti-tamper circuit generates a second resistance across the resistor divider based on a pseudo-random digital value, and wherein the anti-tamper circuit generates the output signal based on the first resistance and based on the second resistance.

9. The integrated circuit of claim 1, wherein the anti-tamper circuit generates the output signal based on the first resistance of the resistor and based on a second resistance that is determined based on a randomly generated value used to control transistors.

10. A method for detecting an attack on an integrated circuit die, wherein the method comprises:
sensing a first resistance of a resistor using a voltage detection circuit, wherein the resistor comprises conductors in a conductive layer of the integrated circuit die, wherein each of the conductors extends across a width of the integrated circuit die, and wherein the conductors are spaced apart across a length of the integrated circuit die; and
generating an output signal based on a change in the first resistance of the resistor that is caused by tampering affecting the conductors.

11. The method of claim 10 further comprising:
generating a pseudo-random digital value using a switch select circuit; and
setting a second resistance across a resistor divider based on the pseudo-random digital value, wherein the resistor divider comprises the resistor.

12. The method of claim 10, wherein generating the output signal further comprises generating a detection voltage using a resistor divider.

13. The method of claim 10, wherein generating the output signal further comprises:
generating a first voltage at a node coupled to the resistor during a protection mode;
generating a second voltage at the node during a profiling mode;
storing the second voltage; and
generating the output signal based on a comparison between the first voltage and the second voltage.

14. The method of claim 10, wherein the conductors are coupled in a pattern that extends back and forth across the length and the width of the integrated circuit die.

15. The method of claim 10 further comprising:
shutting down the integrated circuit die in response to the output signal being asserted.

16. An anti-tamper circuit comprising:
a resistor divider;
a switch select circuit that selects a resistance of the resistor divider based on a pseudo-random value; and
voltage detection circuitry that generates an anti-tamper alert signal indicating when a voltage at a node in the resistor divider differs from a stored value.

17. The anti-tamper circuit of claim 16, wherein the resistor divider comprises conductors in a conductive layer of an integrated circuit die, wherein each of the conductors extends across a width of the integrated circuit die, and wherein the conductors are spaced apart across a length of the integrated circuit die.

18. The anti-tamper circuit of claim 16 further comprising:
transistors controlled by the switch select circuit, wherein each of the transistors is coupled in parallel with a resistor in the resistor divider.

19. The anti-tamper circuit of claim 16, wherein the voltage detection circuitry comprises compare logic circuitry that compares the voltage at the node in the resistor divider with the stored value.

20. The anti-tamper circuit of claim 16, wherein the stored value is generated based on the voltage at the node in the resistor divider during a profiling mode of the anti-tamper circuit, and wherein the voltage detection circuitry generates the anti-tamper alert signal during a protection mode of the anti-tamper circuit.
